(19) United States
(12) Patent Application Publication
(10) Pub. No.: US 2024/0305430 A1
(43) Pub. Date: Sep. 12, 2024

(54) Negative Acknowledgment (NACK) Design and Block Acknowledgement Modification

(71) Applicant: Apple Inc., Cupertino, CA (US)

(72) Inventors: Tianyu Wu, Fremont, CA (US); Ahmad Reza Hedayat, Carlsbad, CA (US); Anuj Batra, Redwood City, CA (US); Jarkko L. Kneckt, Los Gatos, CA (US); Jinjing Jiang, San Jose, CA (US); Lochan Verma, Danville, CA (US); Oren Shani, Saratoga, CA (US); Qi Wang, Sunnyvale, CA (US); Su Khiong Yong, Palo Alto, CA (US); Wook Bong Lee, San Jose, CA (US); Yong Liu, Campbell, CA (US)

(21) Appl. No.: 18/600,572

(22) Filed: Mar. 8, 2024

Related U.S. Application Data
(60) Provisional application No. 63/451,216, filed on Mar. 9, 2023.

(51) Int. Cl. H04L 5/00; H04L 1/00; H04W 80/02

(52) U.S. Cl. CPC H04L 5/0053; H04L 1/0003; H04W 80/02

(57) ABSTRACT

Disclosed are methods, systems, and computer-readable medium to perform operations including detecting a reception opportunity of a physical layer protocol data unit (PPDU) scheduled to be transmitted by a transmitter, where the PPDU includes a preamble and one or more media access control (MAC) PDUs (MPDUs); decoding the preamble of the PPDU; detecting that reception of the one or more MPDUs has failed; and in response to the detecting, preparing a Negative Acknowledgment (NACK) message for transmission to the transmitter.

### CROSS-REFERENCE TO RELATED APPLICATIONS

This application claims priority to U.S. Provisional Application No. 63/451,216, filed on Mar. 9, 2023, which is incorporated herein by reference in its entirety.

### BACKGROUND

Many electronic devices communicate with each other using wireless local area networks (WLANs), such as those based on a communication protocol that is compatible with an Institute of Electrical and Electronics Engineers (IEEE) standard, e.g., the IEEE 802.11 standard (also known as “Wi-Fi”). A WLAN typically includes an access point (AP) that provides one or more stations (STAs) with access to another network, such as the Internet. There are many generations of the IEEE 802.11 standard. More recent generations include 802.11ax (Wi-Fi 6) and 802.11be (Wi-Fi 7).

### SUMMARY

One aspect of the subject matter described in this specification may be embodied in a method that involves detecting a reception opportunity of a physical layer protocol data unit (PPDU) scheduled to be transmitted by a transmitter, where the PPDU includes a preamble and one or more media access control (MAC) PDUs (MPDUs); decoding the preamble of the PPDU; detecting that reception of the one or more MPDUs has failed; and in response to the detecting, preparing a Negative Acknowledgment (NACK) message for transmission to the transmitter.

The previously described implementation is implementable using a method; a non-transitory, computer-readable medium storing computer-readable instructions to perform the method; one or more processors configured to perform the method; a station including processing circuitry configured to cause the station to perform the method; a computer memory interoperably coupled with a hardware processor configured to perform the method or the instructions stored on the non-transitory, computer-readable medium. These and other embodiments may each optionally include one or more of the following features.

In some implementations, the method is performed in a Wi-Fi network or an 802.11 network.

In some implementations, the NACK message includes an indication of a reason of the failed reception.

In some implementations, the reason includes at least one of (i) an aggressive Modulation Coding Scheme (MCS)/Number of Spatial Streams (NSS), (ii) a bursty interference from a conflicted PPDU, incumbent users of the channel or other internal radios, or (iii) a radio not being available.

In some implementations, the NACK message includes information indicative of existence of the receiver.

In some implementations, receiving and decoding the preamble of the PPDU involves successfully decoding the preamble for a PPDU duration and a station ID.

In some implementations, the PPDU duration is in a legacy signal (LSIG) field and the station ID is in an ultra-high reliability signal (UHR-SIG) field.

In some implementations, responsively sending a Negative Acknowledgment (NACK) message for transmission to the transmitter involves determining, based on the PPDU duration, a timing for sending the NACK message to the transmitter.

In some implementations, the timing is a Short Interframe Space (SIFS) after the PPDU duration is complete.

In some implementations, responsively sending a Negative Acknowledgment (NACK) message for transmission to the transmitter involves determining that the station ID matches an ID of the receiver.

In some implementations, the NACK message includes at least one of: one or more reasons for the reception failure of the one or more MPDUs; an interference power; an interference start/end time; a mutual information average signal-to-noise ratio (SNR); a recommended Modulation Coding Scheme (MCS)/Number of Spatial Streams (NSS); a resounding request; or a presence/stay alive indication.

In some implementations, the NACK message is a MAC frame type or a physical layer (PHY) header.

In some implementations, the PHY header does not include a data field, an ultrahigh reliability short training field (UHR-STF), or an UHR legacy training field (UHR-LTF).

In some implementations, the PHY header includes a universal signal (U-SIG) field that is indicative of the NACK message.

In some implementations, the U-SIG field includes a format of the PHY header.

In some implementations, the PHY header does not include an ultrahigh reliability (UHR) signal (UHR-SIG) symbol.

In some implementations, the PHY header includes an ultrahigh reliability (UHR) signal (UHR-SIG) symbol that includes at least one of: an ID of the receiver; a PPDU fail reason; Signal to Interference Noise Ratio (SINR) report; MCS/NSS recommendations; interference power; or interference start/end time.

In some implementations, the PPDU fail reason includes at least one of a general feedback subfield, a fail reason subfield, or a fail reason specific feedback subfield.

In some implementations, the fail reason subfield is defined as a bitmap to signal multiple fail reasons.

In some implementations, a length of the PHY header is 36 microseconds.

In some implementations, the MAC frame type includes a reserved control frame subtype for NACK.

In some implementations, the MAC frame type includes a reserved value in control frame extension.

In some implementations, the MAC frame type includes a new NACK frame format based on an existing ACK frame format.

In some implementations, the MAC frame type is defined as a variant of a Block Ack (BA) frame.

In some implementations, the variant of the BA frame includes at least one of a frame control field, a duration field, a receiver address field, a transmitter address field, a BA control field, a BA information field, or a Frame Check Sequence (FCS) field.

In some implementations, the BA control field includes a NACK report.

In some implementations, the NACK report includes at least one of: an ID of the receiver;
a PPDU fail reason; Signal e to Interference Noise Ratio (SINR) report; MCS/NSS recommendations; interference power; or interference start/end time.

In some implementations, the BA control field includes an indication that the variant of the BA frame is used for the NACK message.

The details of one or more embodiments of these systems and methods are set forth in the accompanying drawings and description below. Other features, objects, and advantages of these systems and methods will be apparent from the description, drawings, and claims.

### BRIEF DESCRIPTION OF THE FIGURES

FIG. 1 illustrates a block diagram of example of electronic devices communicating wirelessly, according to some implementations.

FIG. 2A illustrates an acknowledgement message (ACK) and a Block ACK (BA), according to some implementations.

FIG. 2B and FIG. 2C illustrate example scenarios for using NACK and modified BA, according to some implementations.

FIGS. 3A-3J illustrate example NACK usage scenarios, according to some implementations.

FIG. 4 illustrates a workflow for transmitting a NACK, according to some implementations.

FIG. 5 illustrates an example PHY NACK, according to some implementations.

FIG. 6A illustrates an example U-SIG of a PHY NACK frame, according to some implementations.

FIG. 6B illustrates an example UHR-SIG of a PHY NACK, according to some implementations.

FIG. 6C illustrates an example NACK report of a PHY NACK, according to some implementations.

FIG. 7 illustrates another example PHY NACK, according to some implementations.

FIG. 8A illustrates another example U-SIG of a PHY NACK frame, according to some implementations.

FIG. 8B illustrates another example NACK report, according to some implementations.

FIG. 9 illustrates a MAC NACK frame based on a block acknowledgement frame format, according to some implementations.

FIGS. 10A, 10B, and 10C illustrate examples of a MAC NACK defined as a new subtype of control frame, according to some implementations.

FIG. 11 illustrates a modified BA, according to some implementations.

FIG. 12 illustrates a flowchart of an example method, according to some implementations.

FIG. 13 illustrates an example electronic device, according to some implementations.

### DETAILED DESCRIPTION

This disclosure describes systems and methods that define negative acknowledgement (NACK) messages for Wi-Fi systems. In some examples, the NACK, which is sent from a receiver station (Rx STA) to a transmitter station (Tx STA, e.g., an access point), carries information indicating the existence of the Rx STA and/or a reason for a failed transmission from the Tx STA to the Rx STA. This disclosure also describes systems and methods that provide modifications to block ACK (BA) message to support fast link adaptation.

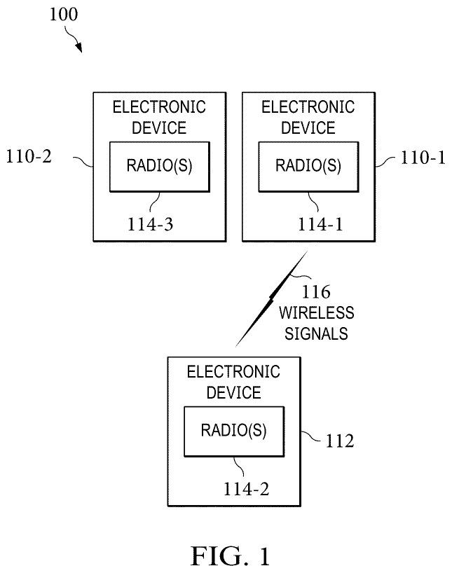

FIG. 1 illustrates a block diagram 100 of example of electronic devices communicating wirelessly, according to some implementations. Notably, one or more electronic devices 110 (such as a smartphone, a laptop computer, a notebook computer, a tablet, or another such electronic device) and access point (AP) 112 may communicate wirelessly in a WLAN using an IEEE 802.11 communication protocol. Thus, electronic devices 110 may be associated with or may have a connection with access point 112. For example, electronic devices 110 and access point 112 may wirelessly communicate while: detecting one another by scanning wireless channels, transmitting and receiving beacons or beacon frames on wireless channels, establishing connections (e.g., by transmitting connect requests), and/or transmitting and receiving packets or frames (which may include the request and/or additional information, such as data, as payloads). Note that the access point 112 may provide access to a network, such as the Internet, via an Ethernet protocol, and may be a physical access point or a virtual or “software” access point that is implemented on a computer or an electronic device. In the discussion that follows, electronic devices 110 are sometimes referred to as “recipient electronic devices,” “receiver (Rx) stations,” or non-AP stations. And the access point (AP) 112 is also referred to as a “transmitter (Tx) station” or “AP station.”

Although the network environment shown in FIG. 1 is provided as an example, in alternative implementations, different numbers and/or types of electronic devices may be present. For example, some implementations may include more or fewer electronic devices. As another example, in other implementations, different electronic devices can be transmitting and/or receiving packets or frames. In some implementations, multiple links may be used during communication between electronic devices 110.

Electronic devices 110 and access point 112 may include subsystems, such as a networking subsystem, a memory subsystem, and a processor subsystem. In addition, electronic devices 110 and access point 112 may include radios 114 in the networking subsystems. More generally, electronic devices 110 and access point 112 can include (or can be included within) any electronic devices with networking subsystems that enable electronic devices 110 and access point 112, respectively, to wirelessly communicate with another electronic device. This can include transmitting beacons on wireless channels to enable the electronic devices to make initial contact with or to detect each other, followed by exchanging subsequent data/management frames (such as connect requests) to establish a connection, configure security options, transmit and receive packets or frames via the connection, etc.

As shown in FIG. 1, wireless signals 116 are communicated by one or more radios 114-1 and 114-2 in electronic device 110-1 and access point 112, respectively. For example, as noted previously, electronic device 110-1 and access point 112 may exchange packets or frames using a Wi-Fi communication protocol in a WLAN. Further, one or more radios 114-1 may receive wireless signals 116 that are transmitted by one or more radios 114-2 via one or more links between electronic device 110-1 and access point 112. Alternatively, the one or more radios 114-1 may transmit wireless signals 116 that are received by the one or more radios 114-2.

In some implementations, wireless signals 116 are communicated by one or more radios 114 in electronic devices 110 and access point 112, respectively. For example, one or more radios 114-1 and 114-3 may receive wireless signals 116 that are transmitted by one or more radios 114-2 via one or more links between electronic devices 110-1 and 110-2, and access point 112.

In some implementations, the access point 112 may group the electronic devices 110 into a target station set. The target station set concept comes from downlink multi-user transmission where the access point 112 can transmit to multiple stations simultaneously in one physical layer protocol data unit (PPDU) using OFDMA or MU-MIMO. Here, target station set is a set of stations that can simultaneously be served by the access point 112. The stations in the set do not need to share the same PHY parameters, such as Modulation Coding Scheme (MCS), number of streams, etc.

In some implementations, the access point 112 can simultaneously communicate with a plurality of electronic devices 110 using multiuser (MU) techniques, such as MU Multiple Input Multiple Output (MU-MIMO). In some examples, the access point 112 communicates with the electronic devices 110 using frequency multiplexing such that the access point 112 allocates each of the electronic devices a portion of the overall bandwidth. The MU-PPDU includes a sub-PPDU for each of the four electronic devices. The access point 112 may use the MU-PPDU to communicate with devices in the same target set, devices in different target sets, or a combination of both.

In some implementations, the access point 112 and one or more electronic devices may be compatible with an IEEE 802.11 standard that includes trigger-based channel access, e.g., IEEE 802.11ax. In 802.11ax, which is a more recent WLAN standard, Orthogonal Frequency Division Multiple Access (OFDMA) is used to enable simultaneous communications between the access point 112 and multiple electronic devices. OFDMA divides the available physical spectrum into multiple orthogonal sub-channels, or resource units (RUs), which can be allocated to different electronic devices (users). Under the standard, the access point 112 coordinates multiuser OFDMA by broadcasting a trigger frame which, among other things, allocates a RU to each participating electronic device. Each electronic device responds to the trigger frame by transmitting a PPDU to the access point 112 using the allocated RU. The trigger frame can also include power control information. The access point 112 also instructs all users when to start and stop transmitting. Note that access point 112 and the electronic devices may also communicate with one or more legacy electronic devices that are not compatible with the IEEE 802.11 standard (i.e., that do not use multi-user trigger-based channel access).

In some implementations, processing a packet or frame in one of electronic devices 110 and the access point 112 includes: receiving wireless signals 116 encoding a packet or a frame; decoding/extracting the packet or frame from received wireless signals 116 to acquire the packet or frame; and processing the packet or frame to determine information contained in the packet or frame (such as data in the payload).

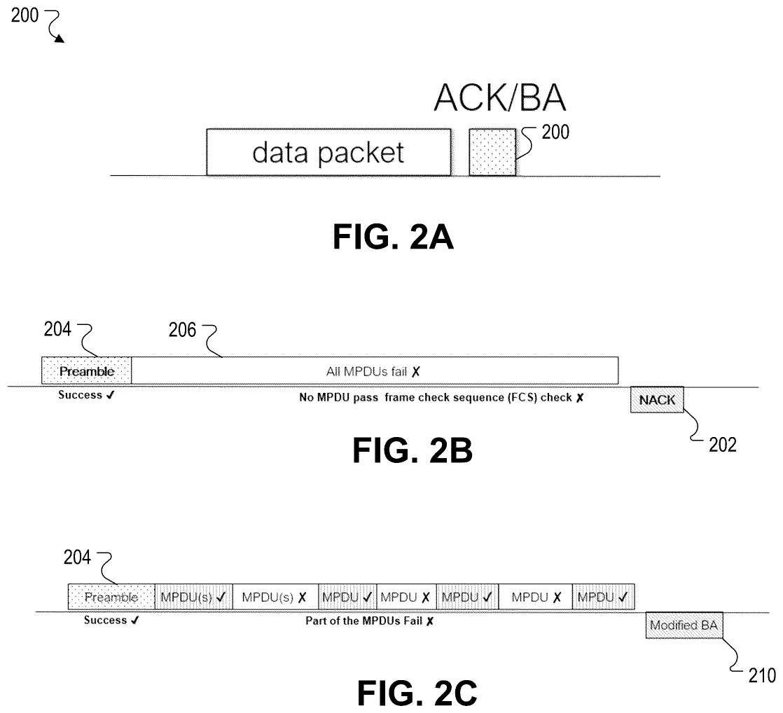

As shown in FIG. 2A, existing Wi-Fi specifications define an acknowledgement message (ACK) and a Block ACK (BA) 200 for a receiver (Rx), e.g., the electronic devices 110, to acknowledge successfully received packets, such as data packets, from a transmitter (Tx), e.g., the access point 112. The existing Wi-Fi specifications, however, do not define a Negative ACK (NACK) frame that can be used when a packet transmission fails, for example, when all of the media access control (MAC) protocol data units (MPDUs) in a PPDU fail.

Note that different transmission failure reasons can lead to different responsive Tx behavior. For instance, if the failure is due to an aggressive MCS, the Tx is configured to use a more robust MCS in the next transmission. And if the failure is due to interference, the Tx is configured to send the Rx a “Request to Send” (RTS) message before attempting another transmission. In scenarios such as Enhanced Multi-Link Single Radio (EMLSR), information on the existence of the Rx is important to the Tx. For instance, the AP Tx behavior can be optimized if the AP knows that an Rx STA is tuned to a particular link and will stay active on that link.

This disclosure describes systems and methods that define NACK for Wi-Fi. In some examples, the NACK, which is sent from an Rx to a Tx, carries information indicating the existence of the Rx and/or a reason for a failed transmission from the Tx to the Rx. One condition for the Rx to be able to send the NACK is that the Rx needs to successfully decode the preamble to obtain a PPDU duration and a station ID. This disclosure also describes systems and methods that provide modifications to BA that support fast link adaptation.

FIG. 2B and FIG. 2C illustrate example scenarios for using NACK and modified BA, according to some implementations. As shown in FIG. 2B, a STA is configured to transmit a NACK 202 when the STA decodes a preamble 204 correctly but fails to decode any of MPDUs 206. The NACK 202 carries feedback information related to the failed transmission of the MPDUs 206. As shown in FIG. 2C, a STA is configured to transmit a modified BA 210 when at least one MPDU is received correctly but there is additional feedback to transmit in the modified BA. As described in more detail below, the feedback information can include: (i) MPDU failure reasons, (ii) interference power and interference start/end time, (iii) mutual information average signal to noise ratio (SNR) and/or recommended MCS/Number of Spatial Streams (NSS), (iv) a resounding request, and/or (v) a presence/stay alive indication. Note that different failure reasons may need different feedback information and lead to different Tx behavior. Also, the interference can result from an in-device interference or Overlapping Basic Service Sets (OBSS). Other feedback candidate feedback information is possible and contemplated herein.

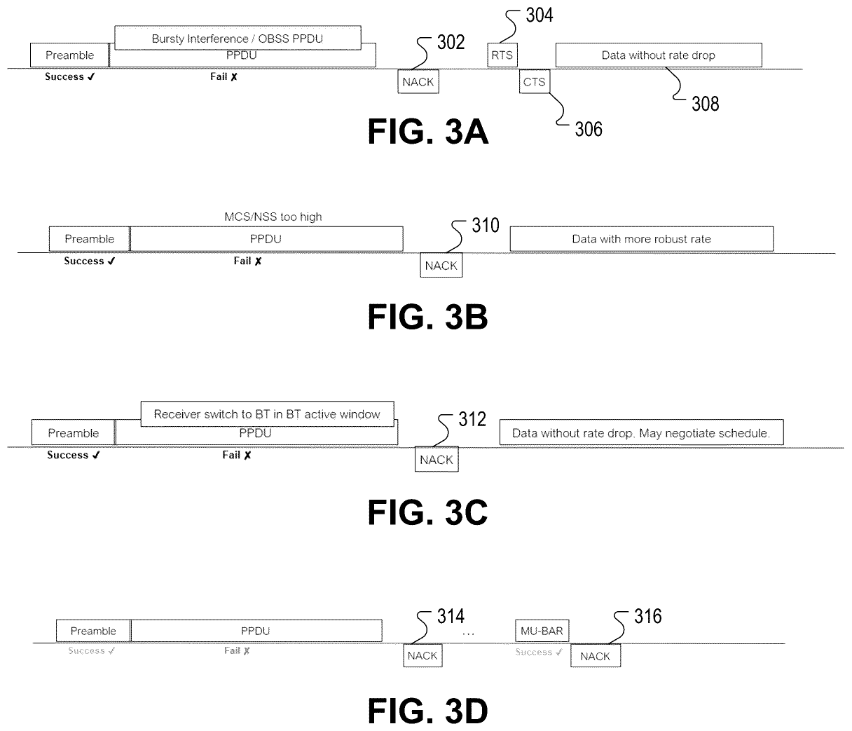

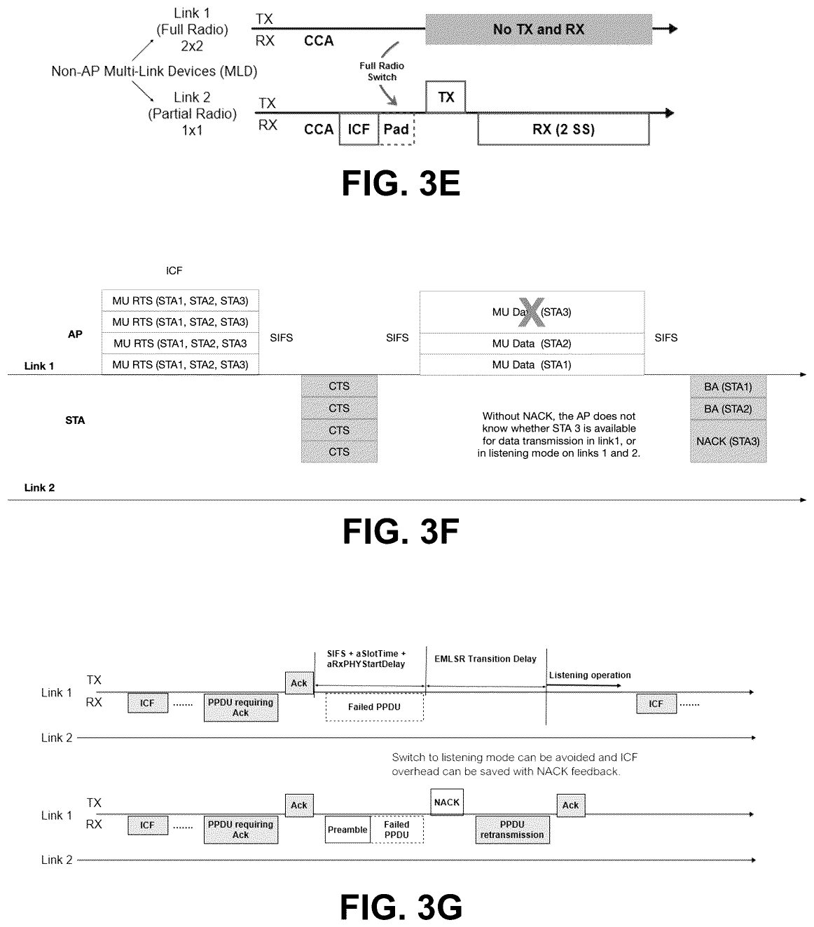

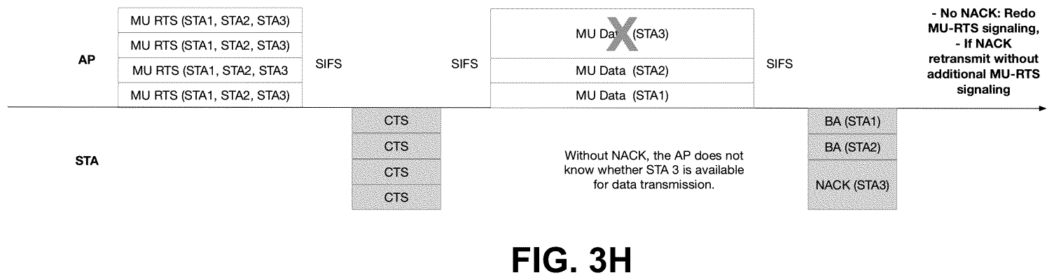

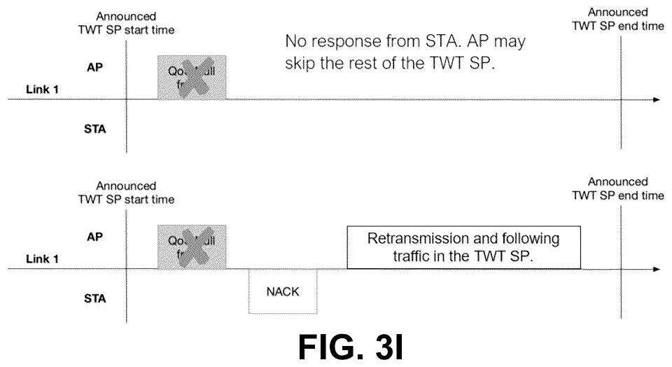

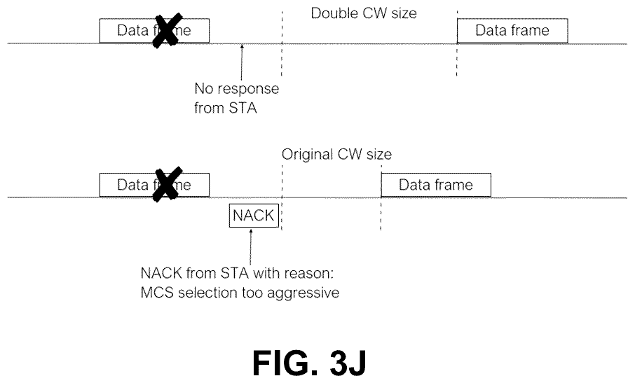

FIGS. 3A-3J illustrate example NACK usage scenarios, according to some implementations. More specifically, FIGS. 3A-3C illustrate example NACK usage scenarios for indicating reasons of a failed transmission from a Tx to an Rx. FIG. 3D illustrates an example NACK usage scenario for responding to a Block Acknowledgment Request (BAR)/Multi-User BAR (MU-BAR) frame. FIGS. 3E-3G illustrate an example NACK usage scenario in enhanced multi-link single radio (EMLSR). FIG. 3H illustrates an example NACK usage scenario for dynamic power saving. FIG. 31 illustrates an example NACK usage scenario for target wake time (TWT). And FIG. 3J illustrates an example NACK usage scenario for contention window (CW) optimization. Other example usage scenarios are possible and contemplated herein.

As shown in FIG. 3A, the reason for a failed transmission from the Tx can be a bursty interference from a conflicted OBSS PPDU. In response to detecting the failed transmission, the Rx transmits to the Tx a NACK 302 that includes the failure reason. As a result of knowing the failure reason, the Tx does not need to drop the rate. Instead, the Tx transmits an RTS 304 and the Rx responds with a Clear to Send (CTS) 306, before the Tx retransmits the data without rate drop in message 308.

As shown in FIG. 3B, another reason for a failed transmission from the Tx is an MCS/NSS that is too aggressive (e.g., too high). In response to detecting the failed transmission, the Rx transmits to the Tx a NACK 310 that includes the failure reason. Based on the failure reason, the Tx applies a link adaptation algorithm that selects a less aggressive MCS/NSS in retransmission. And as shown in FIG. 3C, yet another reasons for a failed transmission from the Tx is that a radio is not available, e.g., the Rx switched to coexisted Bluetooth (BT) for a scheduled transmission. In response to detecting the failed transmission, the Rx transmits to the Tx a NACK 312 that includes the failure reason. As a result of knowing the failure reason, the Tx does not need to drop the rate. Instead, the Tx negotiates the transmission schedule and performs the retransmission without a rate drop.

As shown in FIG. 3D, the Rx can use a NACK to respond to a BAR/MU-BAR frame. In this scenario, the Rx fails PPDU reception completely (e.g., fail all MPDUs) and receives a BAR or an MU-BAR frame. If the Rx has received any MPDU that is not yet acknowledged, the Rx sends a BA as a response to the BAR frame. As shown in FIG. 3D, however, if the Rx has transmitted a NACK 314 as a response to the last PPDU, the Rx sends another NACK 316 as a response to the BAR/MU-BAR frame. The Tx may not have received the NACK 314, so the NACK 316 is retransmitted as a response to the BAR/MU-BAR frame. In some cases, the BAR/MU-BAR frame solicits a BA instead, perhaps by signaling a request for the BA in a dedicated field. In these cases, the Rx sends a BA as a response to the BAR/MU-BAR frame. Here, the bitmap in the BA can be set to all 0s.

Turning to FIGS. 3E-3G, the Rx can use a NACK in EMLSR. As shown in FIG. 3E, the Rx operating in EMLSR includes a full radio and a partial scanning radio. The Rx can receive an initial control frame (ICF) in both links (Link 1 and Link 2) but can only perform full Tx/Rx in one of the links. Thus, the Tx needs to send an ICF to the Rx before using a link for full Tx/Rx. The Rx will switch the full radio to the specified link when the ICF is received. The Rx may switch to listening mode if no PPDU is received within a Point Coordination Function Interframe Space (PIFS) time. A failed PPDU with a broken preamble may put the Rx back to listening mode or even switch the full radio to the other link. If the Tx does not receive a BA for a PPDU, the Tx does not know which link parks the full radio of the Rx. Thus, the Tx needs to send another ICF before the next transmission to the Rx.

In some implementations, the Rx uses a NACK to signal an active link for EMLSR. The Rx responds NACK to the transmission failure of the MPDUs of a PPDU as long as the Rx successfully receives the preamble of the PPDU (e.g., signal [SIG] field decoding success). The NACK can indicate whether the Rx is active in one of the EMLSR links. The NACK can also indicate whether the Rx successfully switched to the target link indicated in the ICF. Further, the NACK can also indicate whether the Rx received at least a preamble of the PPDU and will stay active on the target link. The Tx that receives the NACK can send the next PPDU to the Rx without sending another ICF before the PPDU.

Furthermore, and as shown in FIG. 3F, when the ICF is MU-RTS, the stations respond with identical CTS so the Tx is not to tell which STA is successfully switched to the link. Typically, an ACK/BA that follows the PPDU indicates a successful switch. However, transmission failure of the PPDU implies switch failure. To avoid this, a NACK frame can notify the AP that the switch is successful and the corresponding STA is active on the specified link but that transmission of the PPDU failed. Therefore, there is no need for the AP to resend the ICF. As shown in FIG. 3G, when a preamble can be successfully decoded, the non-AP STA (the Rx) does not need to switch to listening mode as the NACK can be used to notify the AP (the Tx) that the non-AP STA will stay active in this link. This saves the overhead of the AP resending the ICF to the non-AP STA.

In some implementations, a STA uses a NACK for dynamic power saving. In dynamic Spatial Multiplexing (SM) Power save, the STA may receive DL transmissions only in 1 spatial stream unless the AP has sent an MU-RTS or a Buffer Status Report Poll (BSRP) trigger frame and received a response from the STA. The AP does not know which STA responded to MU-RTS and is ready to receive multiple spatial streams. Usually, the ACK/BA following the PPDU can also serve as indication to the AP. However, if the transmission of the PPDU fails, reporting a NACK can indicate to the AP that MU-RTS/BSRP frame is successfully received and the STA is ready to receive multiple spatial streams. Thus, with a NACK report, the AP does not need to send MU-RTS again to wake up the STA, thereby saving power.

In some implementations, the NACK can be used for Target Wake Time (TWT). As shown in FIG. 3I, the beginning of a TWT SP start time, the STA availability needs to be checked. Any response from the STA can serve as availability indication, such as ACK, BA, CTS, Triggered UL traffic, or QoS Null with BSR A-control frame, etc. However, if the first PPDU failed and there is no response from STA, the AP may consider the STA is not available in this TWT service period (SP). If the first PPDU failed, but the preamble is corrected decoded, reporting a NACK can indicate that the STA is available for the TWT SP. Thus, waste of a TWT SP for the STA can be avoided.

Other uses for NACK are possible. As an example, and as shown in FIG. 3J, a STA can use NACK for contention window (CW) optimization. Without knowing the reason of a failed PPDU, a Tx may double the contention window size for the next transmission. However, if the PPDU failure is not due to collision, doubling the CW size is not necessary. With the STA sending NACK to provide the failure reason, the Tx can optimize CW window for next transmission. For instance, if the PPDU is lost due to an aggressive MCS, doubling the CW size will hurt the efficiency.

In some implementations, to support a NACK report, the Rx needs to successfully decode the preamble. Specifically, the Rx decodes the LSIG length field to obtain the length of the failed PPDU and the STA ID field in UHR SIG field. This information enables the Rx to decide whether to respond NACK, and if so, to determine the timing for transmitting the NACK frame. Specifically, if the STA-ID in the preamble matches the Rx's STA-ID and the whole payload (all MPDUs) decoding fails, the Rx is configured to respond with a NACK frame. In some examples, the Rx responds with the NACK frame a Short Interframe Space (SIFS) after the end of the failed PPDU. The Rx calculates the SIFS from the length field in the LSIG.

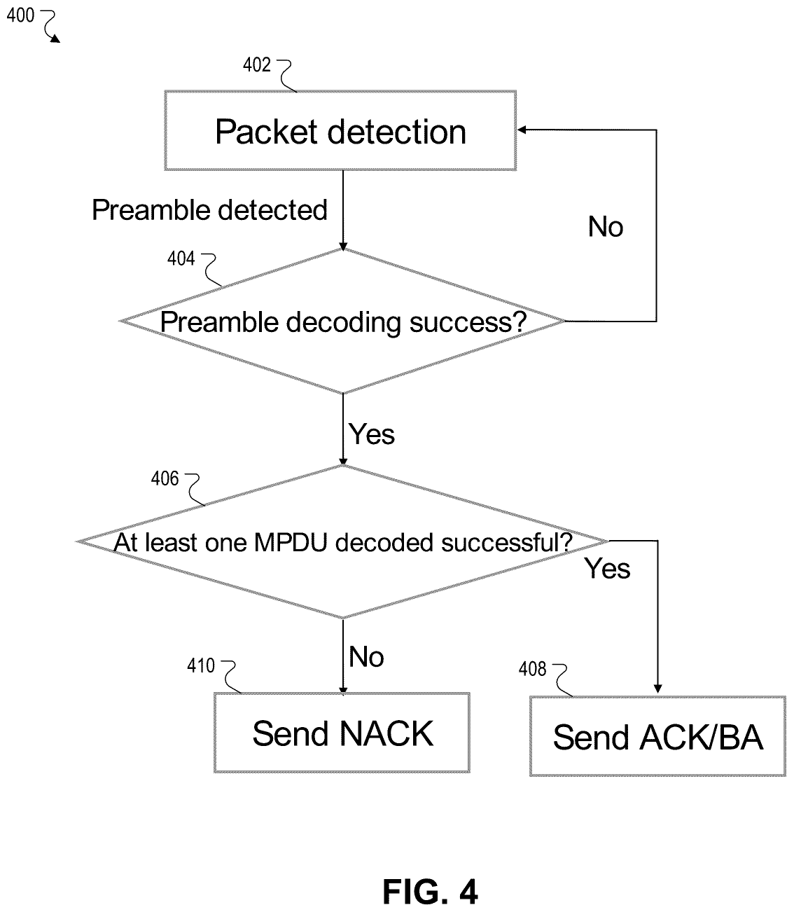

FIG. 4 illustrates a workflow 400 for transmitting a NACK, according to some implementations. As shown in FIG. 4, an Rx, at step 402, detects a packet from a Tx. At step 404, the Rx attempts to decode the preamble of the received packed. If the Rx does not successfully decode the packet, the Rx returns to step 402 until it detects a new packet. Conversely, if the RX successfully decodes the preamble, the Rx moves to step 406. At step 406, the Rx determines whether the Rx has successfully decoded at least one MPDU. If the Rx has successfully decoded at least one MPDU, the Rx moves to step 408 of sending an ACK/BA to the Tx. Conversely, if the Rx has not successfully decoded at least one MPDU, the Rx moves to step 410 of sending a NACK to the Tx.

In some implementations, the NACK frame can be a new MAC frame type or a PHY header without payload. The MAC frame can be embedded in a DL MU PPDU or an UL TB PPDU. Additionally, the MAC frame allows more information to be carried in the NACK. The overhead, however, will be larger than a PHY NACK. Conversely, with a PHY header design, the overhead is smaller than the new MAC frame but the information bits can only be carried in a few redefined SIG fields. Thus, the number of bits is limited. Additionally, since the preamble structure of a PHY NACK is different from the preamble for MU PPDU and TB PPDU, it is harder to embed a PHY NACK into a DL MU PPDU or an UL TB PPDU. The following disclosure describes the PHY NACK and the MAC NACK in more detail.

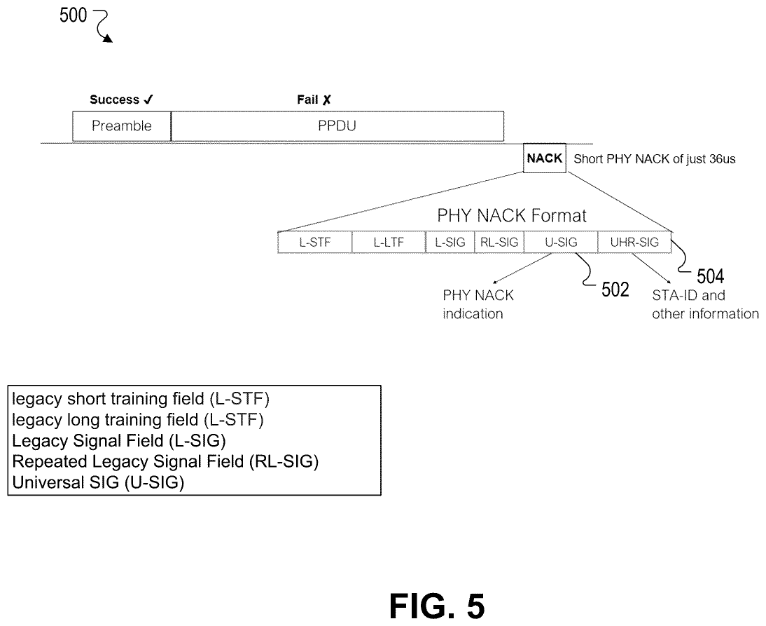

FIG. 5 illustrates an example PHY NACK 500, according to some implementations. In some examples, the PHY NACK 500 is a short PHY that has a length of 36 microsecond (us). As shown in FIG. 5, the PHY NACK does not have a data field, an UHR-STF field, or an UHR-LTF field. The PHY NACK can use a U-SIG field 502 to indicate that it is a PHY NACK frame. Further, the PHY NACK can use an UHR-SIG symbol 504 to indicate the STA ID of the target STA and/or additional report information bits such as the PPDU failure reason, an SINR report, MCS/NSS recommendations, interference power, and/or interference start/end time. With the PHY NACK format indicated in the U-SIG field 502, the UHR-SIG symbol 504 can be redefined in the PHY NACK to more efficiently carry the NACK report information.

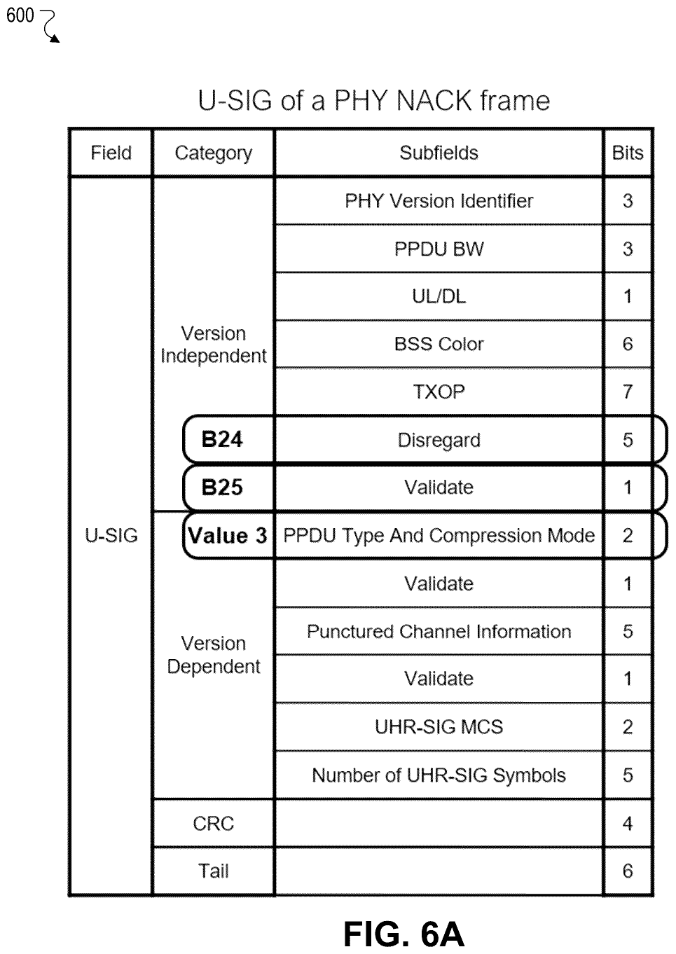

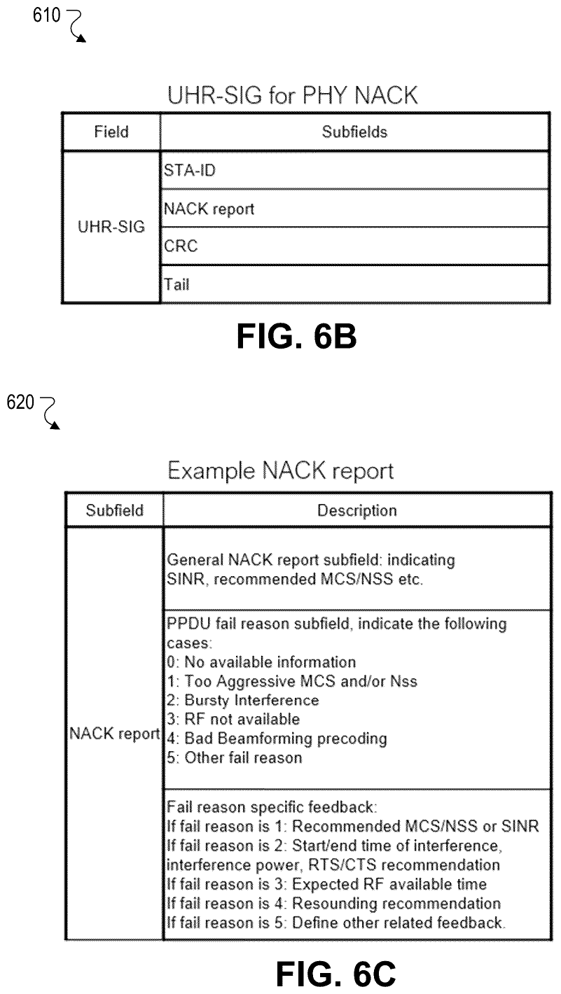

FIG. 6A illustrates an example U-SIG 600 of a PHY NACK frame, according to some implementations. As stated, the PHY NACK can include signaling in the preamble. More specifically, the PHY NACK can use a U-SIG field to indicate a PHY NACK format. Further, the PHY NACK can use a reserved bit, e.g., a disregard bit (field B24) or a validate bit (field B25), or a reserved value of a subfield in U-SIG to indicate the PHY NACK frame. As a first example, the PHY NACK uses a reserved bit such as B24 or B25 in U-SIG-1, or B8 in U-SIG-2 to signal a PHY NACK frame. As a second example, the PHY NACK uses a reserved value such as value 3 of the “PPDU Type And Compression mode” subfield. In this example, the STA sets this subfield to “3” to indicate a PHY NACK.

FIG. 6B illustrates an example UHR-SIG 610 of a PHY NACK, according to some implementations. In some examples, the PHY NACK uses an UHR-SIG field to indicate the STA ID of the target STA and the additional NACK report information bits. For PHY NACK, the information typically carried in an UHR-SIG common field is not needed, and therefore, the UHR-SIG content can be redefined for the PHY NACK. The SIG content can carry an STA-ID (defined in 11 bits) and a NACK report.

FIG. 6C illustrates an example NACK report 620 of a PHY NACK, according to some implementations. The NACK report can include a general feedback subfield, a failure reason subfield, and a failure reason specific feedback subfield. For the failure reason subfield, if the Rx STA detected multiple failure reasons, the Rx can decide the most important failure reason to report, or the failure reason subfield can be defined as a bitmap to signal multiple failure reasons. For this design, the failure reason specific feedback subfield can carry multiple failure reason specific feedback corresponding to each of the failure reasons in the bitmap. In this case, the failure reason specific feedback subfield will have a variable length.

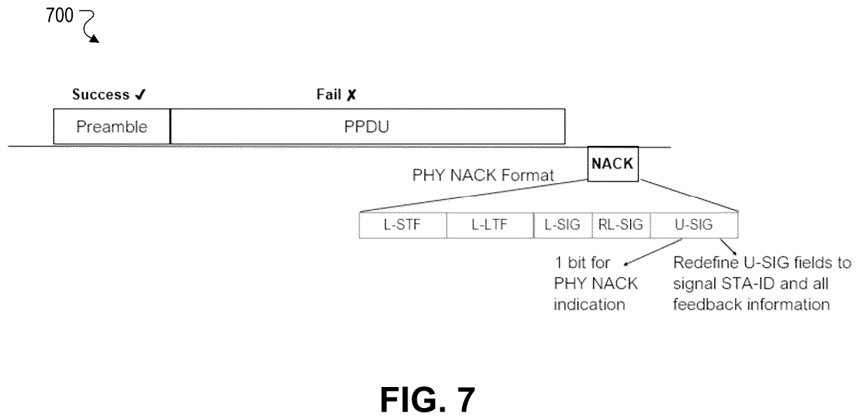

FIG. 7 illustrates another example PHY NACK 700, according to some implementations. In this example, to further reduce the NACK frame length, the U-SIG field can be redefined and the UHR-SIG is removed from PHY NACK. In these implementations, 1 bit indicates NACK format. Additionally, all the subfields in version dependent category for PHY NACK are redefined. Here, the remaining 17 bits can be used to carry STA-ID and the NACK report.

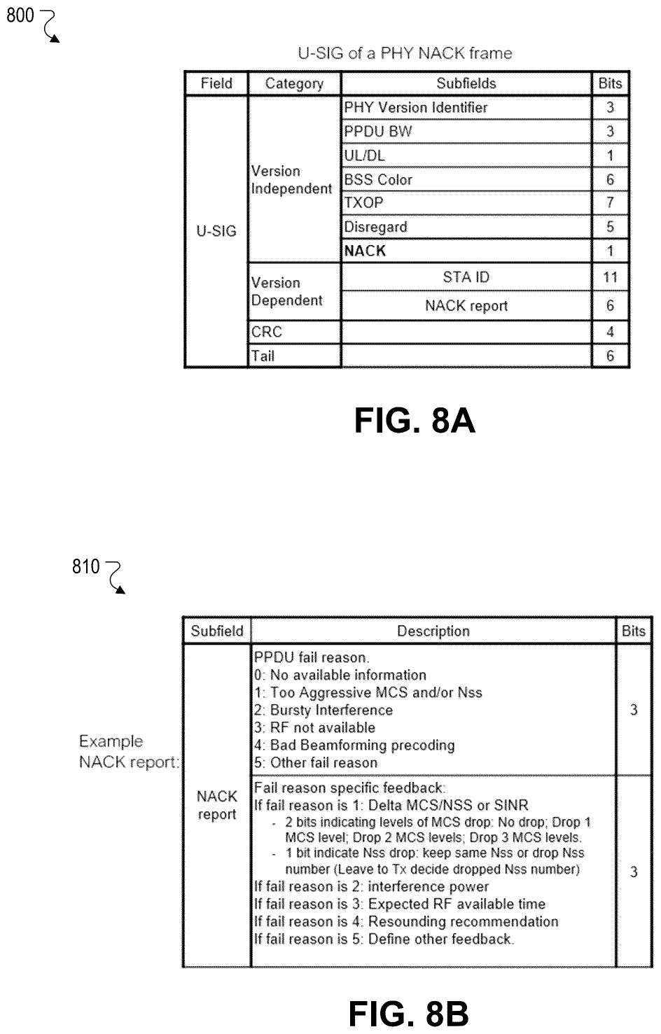

FIG. 8A illustrates another example U-SIG 800 of a PHY NACK frame, according to some implementations. In the example U-SIG 800, 1 bit indicates NACK format. Additionally, all the subfields in the version dependent category for PHY NACK are redefined. Here, the remaining 17 bits can be used to carry STA-ID and the NACK report. As shown in FIG. 8A, the U-SIG 800 uses 11 bits for STA-ID and 6 bits to carry a NACK report.

FIG. 8B illustrates another example NACK report 810, according to some implementations. As shown in FIG. 8B, the NACK report 810 includes 3 bits dedicated for the failure reason and 3 bits for the failure reason specific feedback.

In some implementations, a MAC NACK frame is defined as a variation of a BA frame. In these implementations, the MAC NACK reuses existing BA frame formats by redefining a reserved BA Type, e.g., BA Type 4, as a MAC NACK frame. In the BA frame, the MAC NACK redefines the BA Information field for MAC NACK, e.g., to carry a NACK report. The content of the NACK report can be the same as the NACK report used in the PHY NACK. Furthermore, the bitmap in the BA Information field can be set to all 0s, can be replaced with a short bitmap with all 0s, or can be removed.

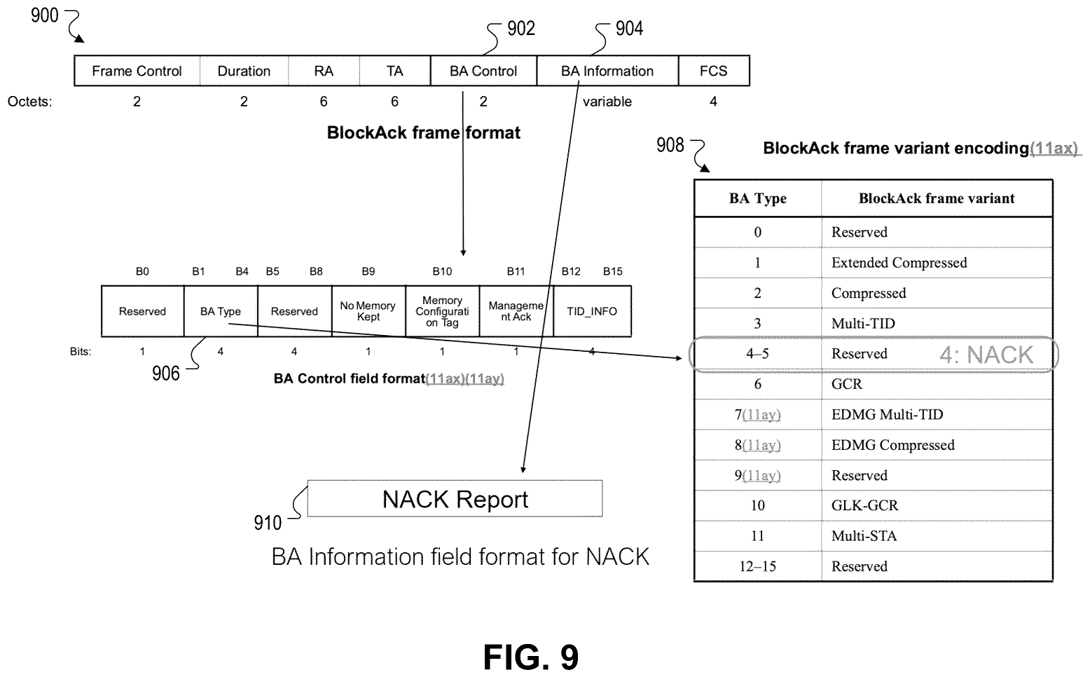

FIG. 9 illustrates a MAC NACK frame 900 based on a block acknowledgement frame format, according to some implementations. As shown in FIG. 9, the MAC NACK frame 900 includes a Frame Control field, a Duration field, receiver address (RA) field, a transmitter address (TA) field, a BA Control field 902, a BA information field 904, and a frame check sequence (FCS) field. As also shown in FIG. 9, the BA Control field 902 includes a BA type field 906 (among other fields). As shown in table 908, a reserved BA type can be assigned to MAC NACK frames. The BA Information field 904, which has variable length, is used to carry a NACK report 910.

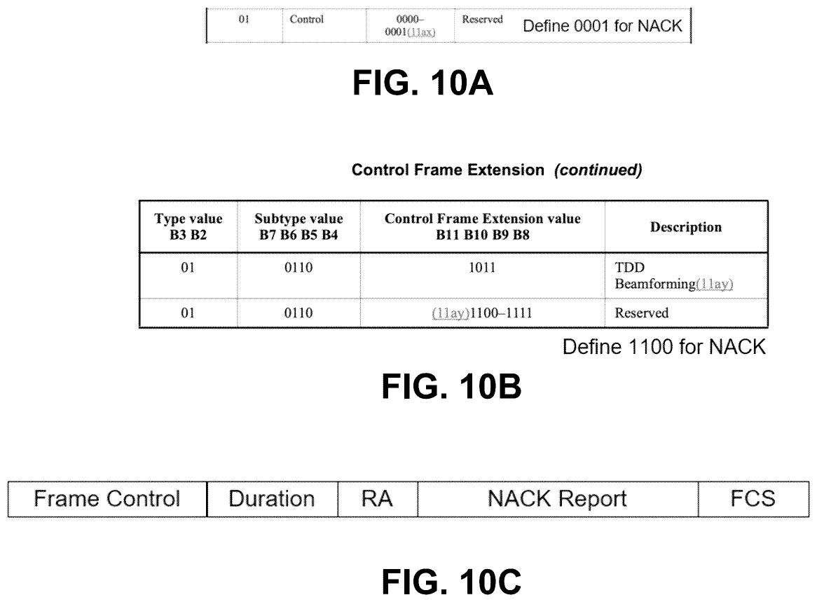

FIGS. 10A, 10B, and 10C illustrate examples of a MAC NACK defined as a new subtype of control frame, according to some implementations. As shown in FIG. 10A, a reserved control frame subtype, such as subtype 0001, can be used for NACK. Alternatively, and as shown in FIG. 10B, a reserved value in a control frame extension, such as 1100, is used to define NACK. Alternatively, and as shown in FIG. 10C, a new frame format is defined for NACK. For example, the new frame format can be similar to ACK's frame format. As shown in FIG. 10C, the new NACK frame includes a Frame Control field, a Duration field, an RA field, a NACK Report field, and an FCS field.

In some implementations, when some MPDUs are decoded correctly and a BA can be reported, a Rx is configured to use a modified BA to provide additional feedback to improve traffic. For example, the Rx can provide feedback on SINR/interference level/interference time, which can help the Tx enhance the link adaptation algorithm.

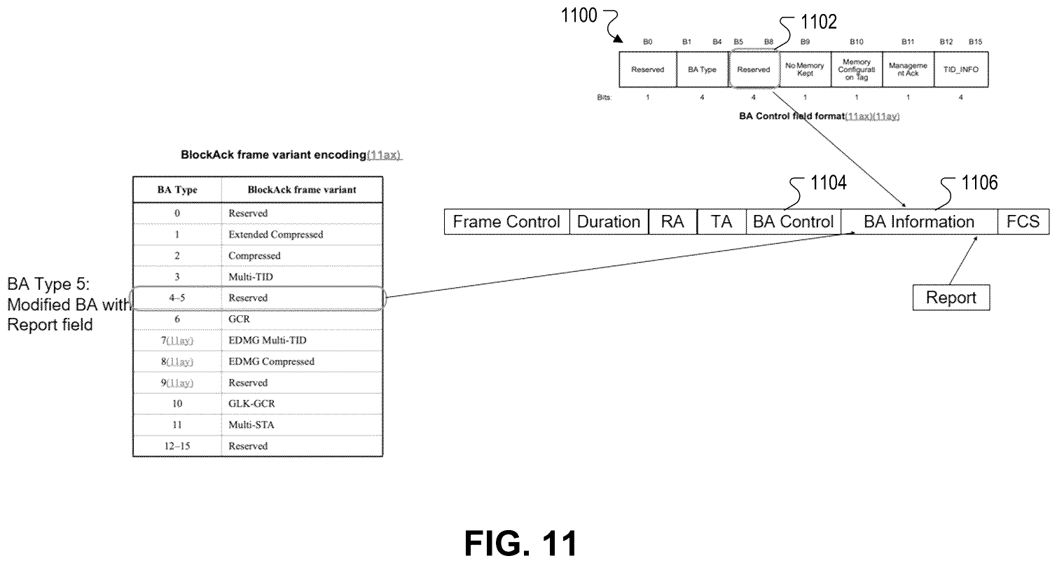

FIG. 11 illustrates a modified BA 1100, according to some implementations. As shown in FIG. 11, an Rx can use a Reserved bit 1102 in a BA Control field 1104 to indicate existence of a Report field within BA Information 1106. For example, “B5” set to 0 indicates there is a Report field within the BA information field. Alternatively, a reserved value in BA Type is used to indicate a modified BA with a Report field.

In some implementations, if the non-AP STA decoded both the preamble and trigger frames, but failed to decode the MPDUs that followed, the NACK can be sent on allocated resource unit (RU). If the Rx STA uses a separate RU to send a more robust trigger for BA, the chances of sending NACK can be increased. The NACK to MU PPDU needs to be shorter than or equal to length of triggered BA for other STAs. The AP may trigger modified BA for all the target STAs to align the length of triggered BA. If more processing time is needed for modified BA or if the AP can't align the length of modified BA, 1 reserved bit is used in immediate BA to request AP sending BAR to retrieve additional information in modified BA or NACK with extended length.

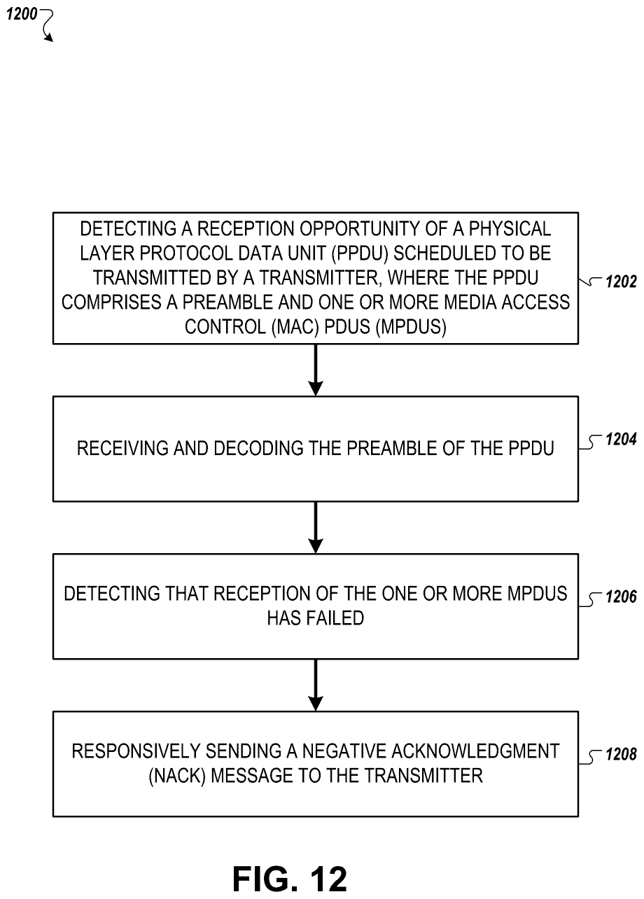

FIG. 12 illustrates a flowchart of an example method 1200, according to some implementations. For clarity of presentation, the description that follows generally describes method 1200 in the context of the other figures in this description. For example, method 1200 can be performed by a receiver. It will be understood that method 1200 can be performed, for example, by any suitable system, environment, software, hardware, or a combination of systems, environments, software, and hardware, as appropriate. In some implementations, various steps of method 1200 can be run in parallel, in combination, in loops, or in any order.

At step 1202, method 1200 involves detecting a reception opportunity of a physical layer protocol data unit (PPDU) scheduled to be transmitted by a transmitter, where the PPDU includes a preamble and one or more media access control (MAC) PDUs (MPDUs).

At step 1204, method 1200 involves receiving and decoding the preamble of the PPDU;

At step 1206, method 1200 involves detecting that reception of the one or more MPDUs has failed.

At step 1208, method 1200 involves responsively sending a Negative Acknowledgment (NACK) message to the transmitter.

In some implementations, the method is performed in a Wi-Fi network or a 802.11 network.

In some implementations, the NACK message includes an indication of a reason of the failed reception.

In some implementations, the reason includes at least one of (i) an aggressive Modulation Coding Scheme (MCS)/Number of Spatial Streams (NSS), (ii) a bursty interference from a conflicted PPDU, incumbent users of the channel or other internal radios, or (iii) a radio not being available.

In some implementations, the NACK message includes information indicative of existence of the receiver.

In some implementations, receiving and decoding the preamble of the PPDU involves successfully decoding the preamble for a PPDU duration and a station ID.

In some implementations, the PPDU duration is in a legacy signal (LSIG) field and the station ID is in an ultra-high reliability signal (UHR-SIG) field.

In some implementations, responsively sending a Negative Acknowledgment (NACK) message for transmission to the transmitter involves determining, based on the PPDU duration, a timing for sending the NACK message to the transmitter.

In some implementations, the timing is a Short Interframe Space (SIFS) after the PPDU duration is complete.

In some implementations, responsively sending a Negative Acknowledgment (NACK) message for transmission to the transmitter involves determining that the station ID matches an ID of the receiver.

In some implementations, the NACK message includes at least one of: one or more reasons for the reception failure of the one or more MPDUs; an interference power; an interference start/end time; a mutual information average signal-to-noise ratio (SNR); a recommended Modulation Coding Scheme (MCS)/Number of Spatial Streams (NSS); a resounding request; or a presence/stay alive indication.

In some implementations, the NACK message is a MAC frame type or a physical layer (PHY) header.

In some implementations, the PHY header does not include a data field, an ultrahigh reliability short training field (UHR-STF), or an UHR legacy training field (UHR-LTF).

In some implementations, the PHY header includes a universal signal (U-SIG) field that is indicative of the NACK message.

In some implementations, the U-SIG field includes a format of the PHY header.

In some implementations, the PHY header does not include an ultrahigh reliability (UHR) signal (UHR-SIG) symbol.

In some implementations, the PHY header includes an ultrahigh reliability (UHR) signal (UHR-SIG) symbol that includes at least one of: an ID of the receiver; a PPDU fail reason; Signal to Interference Noise Ratio (SINR) report; MCS/NSS recommendations; interference power; or interference start/end time.

In some implementations, the PPDU fail reason includes at least one of a general feedback subfield, a fail reason subfield, or a fail reason specific feedback subfield.

In some implementations, the fail reason subfield is defined as a bitmap to signal multiple fail reasons.

In some implementations, a length of the PHY header is 36 microseconds.

In some implementations, the MAC frame type includes a reserved control frame subtype for NACK.

In some implementations, the MAC frame type includes a reserved value in control frame extension.

In some implementations, the MAC frame type includes a new NACK frame format based on an existing ACK frame format.

In some implementations, the MAC frame type is defined as a variant of a Block Ack (BA) frame.

In some implementations, the variant of the BA frame includes at least one of a frame control field, a duration field, a receiver address field, a transmitter address field, a BA control field, a BA information field, or a Frame Check Sequence (FCS) field.

In some implementations, the BA control field includes a NACK report.

In some implementations, the NACK report includes at least one of: an ID of the receiver;
a PPDU fail reason; Signal e to Interference Noise Ratio (SINR) report; MCS/NSS recommendations; interference power; or interference start/end time.

In some implementations, the BA control field includes an indication that the variant of the BA frame is used for the NACK message.

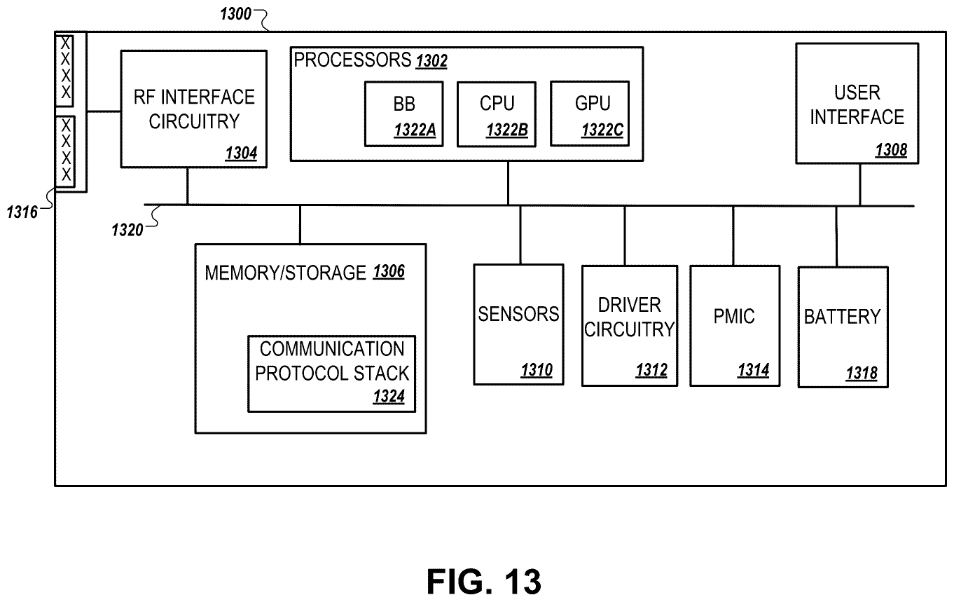

FIG. 13 illustrates an example UE 1300, according to some implementations. The UE 1300 may be similar to and substantially interchangeable with the electronic devices 110 of FIG. 1.

The UE 1300 may be any mobile or non-mobile computing device, such as, for example, mobile phones, computers, tablets, industrial wireless sensors (for example, microphones, pressure sensors, thermometers, motion sensors, accelerometers, inventory sensors, electric voltage/current meters, etc.), video devices (for example, cameras, video cameras, etc.), wearable devices (for example, a smart watch), relaxed-IoT devices.

The UE 1300 may include processors 1302, RF interface circuitry 1304, memory/storage 1306, user interface 1308, sensors 1310, driver circuitry 1312, power management integrated circuit (PMIC) 1314, one or more antenna(s) 1316, and battery 1318. The components of the UE 1300 may be implemented as integrated circuits (ICs), portions thereof, discrete electronic devices, or other modules, logic, hardware, software, firmware, or a combination thereof. The block diagram of FIG. 13 is intended to show a high-level view of some of the components of the UE 1300. However, some of the components shown may be omitted, additional components may be present, and different arrangement of the components shown may occur in other implementations.

The components of the UE 1300 may be coupled with various other components over one or more interconnects 1320, which may represent any type of interface, input/output, bus (local, system, or expansion), transmission line, trace, optical connection, etc. that allows various circuit components (on common or different chips or chipsets) to interact with one another.

The processors 1302 may include processor circuitry such as, for example, baseband processor circuitry (BB) 1322A, central processor unit circuitry (CPU) 1322B, and graphics processor unit circuitry (GPU) 1322C. The processors 1302 may include any type of circuitry or processor circuitry that executes or otherwise operates computer-executable instructions, such as program code, software modules, or functional processes from memory/storage 1306 to cause the UE 1300 to perform operations as described herein.

In some implementations, the baseband processor circuitry 1322A may access a communication protocol stack 1324 in the memory/storage 1306 to communicate over a 3GPP compatible network. In general, the baseband processor circuitry 1322A may access the communication protocol stack to: perform user plane functions at a physical (PHY) layer, medium access control (MAC) layer, radio link control (RLC) layer, packet data convergence protocol (PDCP) layer, service data adaptation protocol (SDAP) layer, and PDU layer; and perform control plane functions at a PHY layer, MAC layer, RLC layer, PDCP layer, RRC layer, and a non-access stratum layer. In some implementations, the PHY layer operations may additionally/alternatively be performed by the components of the RF interface circuitry 1304. The baseband processor circuitry 1322A may generate or process baseband signals or waveforms that carry information in 3GPP-compatible networks. In some implementations, the waveforms for NR may be based cyclic prefix orthogonal frequency division multiplexing (OFDM) “CP-OFDM” in the uplink or downlink, and discrete Fourier transform spread OFDM “DFT-S-OFDM” in the uplink.

The memory/storage 1306 may include one or more non-transitory, computer-readable media that includes instructions (for example, communication protocol stack 1324) that may be executed by one or more of the processors 1302 to cause the UE 1300 to perform various operations described herein. The memory/storage 1306 include any type of volatile or non-volatile memory that may be distributed throughout the UE 1300. In some implementations, some of the memory/storage 1306 may be located on the processors 1302 themselves (for example, L1 and L2 cache), while other memory/storage 1306 is external to the processors 1302 but accessible thereto via a memory interface. The memory/storage 1306 may include any suitable volatile or non-volatile memory such as, but not limited to, dynamic random access memory (DRAM), static random access memory (SRAM), erasable programmable read only memory (EPROM), electrically erasable programmable read only memory (EEPROM), Flash memory, solid-state memory, or any other type of memory device technology.

The RF interface circuitry 1304 may include transceiver circuitry and radio frequency front module (RFEM) that allows the UE 1300 to communicate with other devices over a radio access network. The RF interface circuitry 1304 may include various elements arranged in transmit or receive paths. These elements may include, for example, switches, mixers, amplifiers, filters, synthesizer circuitry, control circuitry, etc.

In the receive path, the RFEM may receive a radiated signal from an air interface via antenna(s) 1316 and proceed to filter and amplify (with a low-noise amplifier) the signal. The signal may be provided to a receiver of the transceiver that downconverts the RF signal into a baseband signal that is provided to the baseband processor of the processors 1302.

In the transmit path, the transmitter of the transceiver up-converts the baseband signal received from the baseband processor and provides the RF signal to the RFEM. The RFEM may amplify the RF signal through a power amplifier prior to the signal being radiated across the air interface via the antenna(s) 1316. In various implementations, the RF interface circuitry 1304 may be configured to transmit/receive signals in a manner compatible with NR access technologies.

The antenna(s) 1316 may include one or more antenna elements to convert electrical signals into radio waves to travel through the air and to convert received radio waves into electrical signals. The antenna elements may be arranged into one or more antenna panels. The antenna(s) 1316 may have antenna panels that are omnidirectional, directional, or a combination thereof to enable beamforming and multiple input, multiple output communications. The antenna(s) 1316 may include microstrip antennas, printed antennas fabricated on the surface of one or more printed circuit boards, patch antennas, phased array antennas, etc. The antenna(s) 1316 may have one or more panels designed for specific frequency bands including bands in FR1 or FR2.

The user interface 1308 includes various input/output (I/O) devices designed to enable user interaction with the UE 1300. The user interface 1308 includes input device circuitry and output device circuitry. Input device circuitry includes any physical or virtual means for accepting an input including, inter alia, one or more physical or virtual buttons (for example, a reset button), a physical keyboard, keypad, mouse, touchpad, touchscreen, microphones, scanner, headset, or the like. The output device circuitry includes any physical or virtual means for showing information or otherwise conveying information, such as sensor readings, actuator position(s), or other like information. Output device circuitry may include any number or combinations of audio or visual display, including, inter alia, one or more simple visual outputs/indicators (for example, binary status indicators such as light emitting diodes “LEDs” and multi-character visual outputs), or more complex outputs such as display devices or touchscreens (for example, liquid crystal displays “LCDs,” LED displays, quantum dot displays, projectors, etc.), with the output of characters, graphics, multimedia objects, and the like being generated or produced from the operation of the UE 1300.

The sensors 1310 may include devices, modules, or subsystems whose purpose is to detect events or changes in its environment and send the information (sensor data) about the detected events to some other device, module, subsystem, etc. Examples of such sensors include, inter alia, inertia measurement units including accelerometers, gyroscopes, or magnetometers; microelectromechanical systems or nanoelectromechanical systems including 3-axis accelerometers, 3-axis gyroscopes, or magnetometers; level sensors; temperature sensors (for example, thermistors); pressure sensors; image capture devices (for example, cameras or lensless apertures); light detection and ranging sensors; proximity sensors (for example, infrared radiation detector and the like); depth sensors; ambient light sensors; ultrasonic transceivers; microphones or other like audio capture devices; etc.

The driver circuitry 1312 may include software and hardware elements that operate to control particular devices that are embedded in the UE 1300, attached to the UE 1300, or otherwise communicatively coupled with the UE 1300. The driver circuitry 1312 may include individual drivers allowing other components to interact with or control various input/output (I/O) devices that may be present within, or connected to, the UE 1300. For example, driver circuitry 1312 may include a display driver to control and allow access to a display device, a touchscreen driver to control and allow access to a touchscreen interface, sensor drivers to obtain sensor readings of sensors 1310 and control and allow access to sensors 1310, drivers to obtain actuator positions of electro-mechanic components or control and allow access to the electro-mechanic components, a camera driver to control and allow access to an embedded image capture device, audio drivers to control and allow access to one or more audio devices.

The PMIC 1314 may manage power provided to various components of the UE 1300. In particular, with respect to the processors 1302, the PMIC 1314 may control power-source selection, voltage scaling, battery charging, or DC-to-DC conversion.

In some implementations, the PMIC 1314 may control, or otherwise be part of, various power saving mechanisms of the UE 1300. A battery 1318 may power the UE 1300, although in some examples the UE 1300 may be mounted deployed in a fixed location and may have a power supply coupled to an electrical grid. The battery 1318 may be a lithium-ion battery, a metal-air battery, such as a zinc-air battery, an aluminum-air battery, a lithium-air battery, and the like. In some implementations, such as in vehicle-based applications, the battery 1318 may be a typical lead-acid automotive battery.

### EXAMPLES

Example 1 includes an apparatus including processing circuitry configured to: detect a reception opportunity of a physical layer protocol data unit (PPDU) scheduled to be transmitted by a transmitter, wherein the PPDU comprises a preamble and one or more media access control (MAC) PDUs (MPDUs); decode the preamble of the PPDU; detect that reception of the one or more MPDUs has failed; and in response to the detecting, prepare a Negative Acknowledgment (NACK) message for transmission to the transmitter.

Example 2 is the apparatus of claim 1, where the method is performed in a Wi-Fi network or a 802.11 network.

Example 3 is the apparatus of claim 1, where the NACK message includes an indication of a reason of the failed reception.

Example 4 is the apparatus of claim 3, where the reason includes at least one of (i) an aggressive Modulation Coding Scheme (MCS)/Number of Spatial Streams (NSS), (ii) a bursty interference from a conflicted PPDU, incumbent users of the channel or other internal radios, or (iii) a radio not being available.

Example 5 is the apparatus of claim 1, where the NACK message includes information indicative of existence of the receiver.

Example 6 is the apparatus of claim 1, where to decode the preamble of the PPDU includes: successfully decoding the preamble for a PPDU duration and a station ID.

Example 7 is the apparatus of claim 6, where the PPDU duration is in a legacy signal (LSIG) field and the station ID is in an ultra-high reliability signal (UHR-SIG) field.

Example 8 is the apparatus of claim 6, where to prepare a Negative Acknowledgment (NACK) message for transmission to the transmitter includes: determining, based on the PPDU duration, a timing for sending the NACK message to the transmitter.

Example 9 is the apparatus of claim 8, where the timing is a Short Interframe Space (SIFS) after the PPDU duration is complete.

Example 10 is the apparatus of claim 6, where to prepare a Negative Acknowledgment (NACK) message for transmission to the transmitter includes: determining that the station ID matches an ID of the receiver.

Example 11 is the apparatus of claim 1, where the NACK message includes at least one of: one or more reasons for the reception failure of the one or more MPDUs; an interference power; an interference start/end time; a mutual information average signal-to-noise ratio (SNR); a recommended Modulation Coding Scheme (MCS)/Number of Spatial Streams (NSS); a resounding request; or a presence/stay alive indication.

Example 12 is the apparatus of claim 1, where the NACK message is a MAC frame type or a physical layer (PHY) header.

Example 13 is the apparatus of claim 12, where the PHY header does not include a data field, an ultrahigh reliability short training field (UHR-STF), or an UHR legacy training field (UHR-LTF).

Example 14 is the apparatus of claim 12, where the PHY header includes a universal signal (U-SIG) field that is indicative of the NACK message.

Example 15 is the apparatus of claim 14, where the U-SIG field includes a format of the PHY header.

Example 16 is the apparatus of claim 12, where the PHY header does not include an ultrahigh reliability signal (UHR-SIG) symbol.

Example 17 is the apparatus of claim 12, where the PHY header includes an ultrahigh reliability signal (UHR-SIG) symbol that includes at least one of: an ID of a receiver; a PPDU fail reason; Signal to Interference Noise Ratio (SINR) report; MCS/NSS recommendations; interference power; or interference start/end time.

Example 18 is the apparatus of claim 17, wherein the PPDU fail reason comprises at least one of a general feedback subfield, a fail reason subfield, or a fail reason specific feedback subfield.

Example 19 is the apparatus of claim 18, where the fail reason subfield is defined as a bitmap to signal multiple fail reasons.

Example 20 is the apparatus of claim 12, where a length of the PHY header is 36 microseconds.

Example 21 is the apparatus of claim 12, where the MAC frame type includes a reserved control frame subtype for NACK.

Example 22 is the apparatus of claim 12, where the MAC frame type includes a reserved value in control frame extension.

Example 23 is the apparatus of claim 12, where the MAC frame type includes a new NACK frame format based on an existing ACK frame format.

Example 24 the apparatus of claim 12, where the MAC frame type is defined as a variant of a Block Ack (BA) frame.

Example 25 is the apparatus of claim 24, where the variant of the BA frame includes at least one of a frame control field, a duration field, a receiver address field, a transmitter address field, a BA control field, a BA information field, or a Frame Check Sequence (FCS) field.

Example 26 is the apparatus of claim 25, where the BA control field includes a NACK report.

Example 27 is the apparatus of claim 26, where the NACK report includes at least one of: an ID of a receiver; a PPDU fail reason; Signal to Interference Noise Ratio (SINR) report; MCS/NSS recommendations; interference power; or interference start/end time.

Example 28 is the apparatus of claim 25, where the BA control field includes an indication that the variant of the BA frame is used for the NACK message.

Example 29 may include one or more non-transitory computer-readable media including instructions to cause an electronic device, upon execution of the instructions by one or more processors of the electronic device, to perform one or more elements described in or related to any of examples 1-28, or any other method or process described herein.

Example 30 may include an apparatus including logic, modules, or circuitry to perform one or more elements described in or related to any of examples 1-28, or any other method or process described herein.

Example 31 may include a method, technique, or process as described in or related to any of examples 1-28, or portions or parts thereof.

Example 32 may include an apparatus including: one or more processors and one or more computer-readable media including instructions that, when executed by the one or more processors, cause the one or more processors to perform the operations as described in or related to any of examples 1-28, or portions thereof.

Example 33 may include a method of communicating in a wireless network as shown and described herein.

Example 34 may include a system for providing wireless communication as shown and described herein. The operations or actions performed by the system can include the methods of any one of examples 1-28.

Example 35 may include a device for providing wireless communication as shown and described herein. The operations or actions performed by the device can include the methods of any one of examples 1-28.

Various components may be described as performing a task or tasks, for convenience in the description. Such descriptions should be interpreted as including the phrase “configured to.” Reciting a component that is configured to perform one or more tasks is expressly intended not to invoke 35 U.S.C. § 112(f) interpretation for that component.

For one or more embodiments, at least one of the components set forth in one or more of the preceding figures may be configured to perform one or more operations, techniques, processes, or methods as set forth in the example section below. For example, the baseband circuitry as described above in connection with one or more of the preceding figures may be configured to operate in accordance with one or more of the examples set forth below. For another example, circuitry associated with a UE, base station, network element, etc. as described above in connection with one or more of the preceding figures may be configured to operate in accordance with one or more of the examples set forth below in the example section.

Any of the above-described examples may be combined with any other example (or combination of examples), unless explicitly stated otherwise. The foregoing description of one or more implementations provides illustration and description, but is not intended to be exhaustive or to limit the scope of embodiments to the precise form disclosed. Modifications and variations are possible in light of the above teachings or may be acquired from practice of various embodiments.

Although the embodiments above have been described in considerable detail, numerous variations and modifications will become apparent to those skilled in the art once the above disclosure is fully appreciated. It is intended that the following claims be interpreted to embrace all such variations and modifications.

It is well understood that the use of personally identifiable information should follow privacy policies and practices that are generally recognized as meeting or e leeding industry or governmental requirements for maintaining the privacy of users. In particular, personally identifiable information data should be managed and handled so as to minimize risks of unintentional or unauthorized access or use, and the nature of authorized use should be clearly indicated to users.

We claim:

1. An apparatus comprising processing circuitry configured to:
detect a reception opportunity of a physical layer protocol data unit (PPDU) scheduled to be transmitted by a transmitter, wherein the PPDU comprises a preamble and one or more media access control (MAC) PDUs (MPDUs);
decode the preamble of the PPDU;
detect that reception of the one or more MPDUs has failed; and
in response to the detecting, prepare a Negative Acknowledgment (NACK) message for transmission to the transmitter.

2. The apparatus of claim 1, wherein the NACK message comprises an indication of a reason of the failed reception.

3. The apparatus of claim 2, wherein the reason comprises at least one of (i) an aggressive Modulation Coding Scheme (MCS)/Number of Spatial Streams (NSS), (ii) a bursty interference from a conflicted PPDU, incumbent users of the channel or other internal radios, or (iii) a radio not being available.

4. The apparatus of claim 1, wherein the NACK message comprises information indicative of existence of the apparatus.

5. The apparatus of claim 1, wherein to decode the preamble of the PPDU comprises:
successfully decoding the preamble for a PPDU duration and a station ID.

6. The apparatus of claim 5, wherein the PPDU duration is in a legacy signal (LSIG) field and the station ID is in an ultra-high reliability signal (UHR-SIG) field.

7. The apparatus of claim 5, wherein to prepare a Negative Acknowledgment (NACK) message for transmission to the transmitter comprises:
determining, based on the PPDU duration, a timing for sending the NACK message to the transmitter.

8. The apparatus of claim 5, wherein to prepare a Negative Acknowledgment (NACK) message for transmission to the transmitter comprises:
determining that the station ID matches an ID of the apparatus.

9. The apparatus of claim 1, wherein the NACK message comprises at least one of:
one or more reasons for the reception failure of the one or more MPDUs;
an interference power;
an interference start/end time;
a mutual information average signal-to-noise ratio (SNR);
a recommended Modulation Coding Scheme (MCS)/Number of Spatial Streams (NSS);
a resounding request; or
a presence/stay alive indication.

10. The apparatus of claim 1, wherein the NACK message is a MAC frame type or a physical layer (PHY) header.

11. The apparatus of claim 10, wherein the PHY header comprises a universal signal (U-SIG) field that is indicative of the NACK message.

12. The apparatus of claim 10, wherein the PHY header comprises an ultrahigh reliability signal (UHR-SIG) symbol that includes at least one of:
an ID of a receiver;
a PPDU fail reason;
Signal to Interference Noise Ratio (SINR) report;
MCS/NSS recommendations;
interference power; or
interference start/end time.

13. The apparatus of claim 12, wherein the PPDU fail reason comprises at least one of a general feedback subfield, a fail reason subfield, or a fail reason specific feedback subfield.

14. The apparatus of claim 13, wherein the fail reason subfield is defined as a bitmap to signal multiple fail reasons.

15. The apparatus of claim 10, wherein the MAC frame type comprises a reserved control frame subtype for NACK.

16. The apparatus of claim 10, wherein the MAC frame type comprises a reserved value in control frame extension.

17. The apparatus of claim 1, wherein the apparatus is a user equipment or one or more processors.

18. A method comprising:
detecting a reception opportunity of a physical layer protocol data unit (PPDU) scheduled to be transmitted by a transmitter, wherein the PPDU comprises a preamble and one or more media access control (MAC) PDUs (MPDUs);
decoding the preamble of the PPDU;
detecting that reception of the one or more MPDUs has failed; and
in response to the detecting, preparing a Negative Acknowledgment (NACK) message for transmission to the transmitter.

19. The method of claim 18, wherein the NACK message comprises an indication of a reason of the failed reception.

20. One or more processors configured to perform operations comprising:
detecting a reception opportunity of a physical layer protocol data unit (PPDU) scheduled to be transmitted by a transmitter, wherein the PPDU comprises a preamble and one or more media access control (MAC) PDUs (MPDUs);
decoding the preamble of the PPDU;
detecting that reception of the one or more MPDUs has failed; and
in response to the detecting, preparing a Negative Acknowledgment (NACK) message for transmission to the transmitter.
